(19) United States
(12) Patent Application Publication
(10) Pub. No.: US 2026/0338570 A1
(43) Pub. Date: Oct. 29, 2026

(54) METHOD AND APPARATUS FOR GENERATING AND DELIVERING VOICE GUIDANCE

(71) Applicants: HYUNDAI MOTOR COMPANY, Seoul (KR); KIA CORPORATION, Seoul (KR)

(72) Inventors: Young Jae Park, Hwaseong-si (KR); Yoon Jung Lee, Hwaseong-si (KR)

(73) Assignees: HYUNDAI MOTOR COMPANY, Seoul (KR); KIA CORPORATION, Seoul (KR)

(21) Appl. No.: 19/379,226

(22) Filed: Nov. 4, 2025

(30) Foreign Application Priority Data
Apr. 23, 2025 (KR) 10-2025-0053182

(51) Int. Cl. G01C 21/36; G07C 5/02; G10L 13/02; G10L 15/22

(52) U.S. Cl. CPC G01C 21/3629; G07C 5/02; G10L 13/02; G10L 15/22

(57) ABSTRACT

A method of providing voice guidance to a user in a vehicle includes generating voice guidance based on whether at least one of a vehicle status, a driving situation, or user data satisfies at least one predefined condition. The method also includes providing the voice guidance to the user via a speaker.

### CROSS-REFERENCE TO RELATED APPLICATIONS

This application claims the benefit of and priority to Korean Patent Application Number 10-2025-0053182, filed on Apr. 23, 2025, the entire contents of which are hereby incorporated herein by reference.

### TECHNICAL FIELD

The present disclosure relates to a method and an apparatus for generating and delivering voice guidance.

### BACKGROUND

The statements in this section merely provide background information related to the present disclosure and do not necessarily constitute prior art.

When alerted by a warning sound with a visual warning displayed on a vehicle's instrument cluster while driving, a typical measure for the vehicle user is either to visually identify which warning light is on or to manually activate voice recognition before identifying which warning light is on. Attempting to visually verify the content of the warning, the user may suffer from poor visibility of a pop-up or button displayed on a display device due to a short-duration or small area of display, and may risk distracted driving while manipulating a touch screen of the display device.

### SUMMARY

According to an aspect of the present disclosure, a method of providing voice guidance in a vehicle is provided. The method includes generating voice guidance based on whether at least one of a vehicle status, a driving situation, or user data satisfies at least one predefined condition. The method also includes providing the voice guidance to a user via a speaker.

According to another aspect, an apparatus for providing voice guidance in a vehicle is provided. The apparatus includes a processor and a speaker. The processor is configured to generate voice guidance based on whether at least one of a vehicle status, a driving situation, or user data satisfies at least one predefined condition. The speaker is configured to provide the voice guidance to a user.

### BRIEF DESCRIPTION OF THE DRAWINGS

FIG. 1 is a schematic block diagram of an apparatus that may be used to implement a method or apparatus according to at least one embodiment of the present disclosure.

FIG. 2 is a block diagram of a configuration of a voice guidance apparatus according to at least one embodiment of the present disclosure.

FIG. 3 is a flowchart of a voice guidance method for pop-ups from a cluster and audio, video, navigation & telematics (AVNT), according to at least one embodiment of the present disclosure.

FIGS. 4A-C are diagrams illustrating voice guidance processes and responsive action processes for pop-ups on a cluster, according to some embodiments of the present disclosure.

FIG. 5 is a flowchart of a voice guidance method for recommendation pop-ups or recommendation services for features provided by a vehicle, according to at least one embodiment of the present disclosure.

FIGS. 6A-E are diagrams illustrating voice guidance processes and responsive action processes, for the recommendation pop-ups or the recommendation services, according to some embodiments of the present disclosure.

### DETAILED DESCRIPTION

The present disclosure in some embodiments provides a method and apparatus for providing voice guidance to a user based on whether predefined conditions are satisfied.

The objects of the present disclosure are not limited to those particularly described hereinabove. The above and other objects of the present disclosure should be more clearly understood by those having ordinary skill in the art from the following detailed description.

Hereinafter, embodiments of the present disclosure are described in detail with reference to the accompanying drawings. In the following description, like reference numerals designate like elements even when the elements are shown in different drawings. Further, in the following description, where it was determined that a detailed description of known functions and configurations would obscure the gist of the present disclosure, the detailed description thereof has been omitted.

Additionally, various terms such as first, second, A, B, (a), (b), etc., may be used in the present disclosure. These terms are used solely to differentiate one component from other components. These terms do not imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The respective components of the apparatus or method according to embodiments of the present disclosure may be implemented as hardware or software, or hardware and software combined. Additionally, the function of each component may be implemented by software, and the function by software for each component may be implemented to be executed by a processor (e.g., a microprocessor).

When a component, controller, device, element, apparatus, unit or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, or the like may separately embody or be included with one or more processors and a memory, such as a non-transitory computer-readable media, as part of the apparatus. The one or more processors may be configured to implement computer-readable instructions stored in the memory to perform the described operations.

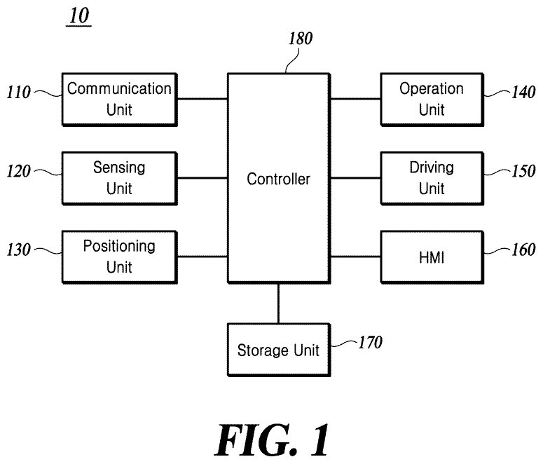

FIG. 1 is a schematic block diagram of an apparatus that may be used to implement a method or apparatus according to at least one embodiment of the present disclosure.

A vehicle 10 according to an embodiment of the present disclosure includes at least one of a communication unit 110, a sensing unit 120, a positioning unit 130, an operation unit 140, a driving unit 150, a human-machine interface (HMI) 160, a storage unit 170, or a controller 180.

The communication unit 110 may exchange signals with devices located externally and internally to the vehicle 10. The communication unit 110 may exchange signals with at least one of an infrastructure device, such as a server or base station, another vehicle, or a terminal. To perform the communication, the communication unit 110 may include at least one of a transmit antenna, a receive antenna, a radio frequency (RF) circuitry capable of implementing various communication protocols, or an RF device. The communication unit 110 may include an internal communication unit and/or an external communication unit. The internal communication unit may transmit or receive various data by using various communication protocols present within the vehicle 10. The protocols utilized by the internal communication unit may include at least one of controller area network (CAN), CAN with flexible data rate (CAN FD), ethernet, local interconnect network (LIN), or FlexRay. The communication protocols may include other protocols for communication between the various devices on board the vehicle. The external communication unit may communicate with other vehicles, infrastructure systems, base stations, roadside devices, etc. by using various communication protocols. The protocols used by the external communication unit may include vehicle-to-everything (V2X) communication, including vehicle-to-vehicle (V2V) communication, vehicle-to-infrastructure (V2I) communication, vehicle-to-network (V2N) communication, and/or vehicle-to-pedestrian (V2P) communication. The infrastructure may be, for example, a roadside unit or server that periodically transmits traffic information in conjunction with a transportation information system (TIS) or intelligent transport system (ITS).

The sensing unit 120 may sense the state of the vehicle 10 and exterior objects. To sense the state of the vehicle 10, the sensing unit 120 may include at least one of an inertial measurement unit (IMU), a distance measuring instrument (DMI) device, a collision sensor, a wheel sensor, a speed sensor, an inclination sensor, a weight detection sensor, a heading sensor, a position module, a vehicle forward/reverse sensor, a battery sensor, a fuel sensor, a tire sensor, a steering sensor, a temperature sensor, a humidity sensor, an ultrasonic sensor, an illumination sensor, or a pedal position sensor. The inertial measurement unit (IMU) sensor may include at least one of an acceleration sensor, a gyro sensor, a magnetic sensor, or a magnetic sensor. The sensing unit 120 may generate vehicle status data based on signals generated by the at least one sensor. For example, the sensing unit 620 may collect orientation information such as heading, yaw rate, etc. of the vehicle 10.

To detect exterior objects, the sensing unit 120 may include at least one of a camera, a radar sensor, a Light Detection and Ranging (LiDAR) sensor, an ultrasonic sensor, or an infrared sensor. The sensing unit 120 may measure at least one of information about the presence or absence of the object, information about the location of the object, information about the distance of the vehicle 10 from the object, or information about the relative speed of the vehicle 10 to the object.

The positioning unit 130 may generate location data of the vehicle 10. The positioning unit 130 may include at least one of a global positioning system (GPS), a differential global positioning system (DGPS), or a global navigation satellite system (GNSS). The positioning unit 130 may generate location data of the vehicle 10 based on signals generated by at least one of the GPS, DGPS, or GNSS. The positioning unit 130 may estimate the location of the vehicle 10 based on the wireless signals received from the communication unit 110. The positioning unit 130 may use the IMU or DMI to estimate the current location of the vehicle 10 based on the vehicle's previous location information, travel distance information, travel time information, speed information, or acceleration information, etc. Based on the location information of the vehicle 10 collected by the positioning unit 130, the controller 180 may estimate a path history and a predicted path of the vehicle 10.

The operation unit 140 receives a user's input for driving. In manual mode, the vehicle 10 may be operated based on signals provided by the operation unit 140. The operation unit 140 may include a steering input device, such as a steering wheel, an acceleration input device, such as an accelerator pedal, and a brake input device, such as a brake pedal.

The driving unit 150 is a device that electrically controls various drive mechanism in the vehicle 10. The driving unit 150 may include, for example, a powertrain drive control unit, a chassis drive control unit, a door/window drive control unit, a safety device drive control unit, a lamp drive control unit, and an air conditioning drive control unit. The driving unit 150 controls the movement of the vehicle 10 based on input signals from the operation unit 140 or control signals from the controller 180.

The human-machine interface (HMI) 160 is adapted to communicate between the vehicle 10 and a person, e.g., an occupant of the vehicle 10 or another vehicle. The HMI 160 may receive input from the user and provide information generated by the vehicle 10 to the user. The vehicle 10 may utilize the HMI 160 to implement a user interface (UI) or user experience (UX). The HMI 160 may include an input device, such as a touch panel, microphone, or the like, and an output device, such as a display device, speaker, or the like. For example, the HMI 160 may include an internal display that displays toward the interior of the vehicle and/or an external display that displays externally of the vehicle.

The storage unit 170 may store computer-readable instructions (e.g., a program) that causes the controller 180 to perform a method according to at least one embodiment of the present disclosure. For example, the program may include a plurality of instructions executable by a processor, and the plurality of instructions may be executed by the processor to perform a method according to at least one embodiment of the present disclosure.

The storage unit 170 may include a single memory or a plurality of memories. When the storage unit 170 includes a plurality of memories, they may be physically separated. The storage unit 170 may include at least one of volatile memory or non-volatile memory. The volatile memory may include, for example, static random access memory (SRAM) or dynamic random access memory (DRAM), and the non-volatile memory may include, for example, flash memory.

The storage unit 170 may store map information. The map information may be one of a navigation map and/or a high definition map (HD map). The high definition map may be received in real time from an external device, or may be stored in advance. The navigation map may include geographic information, road information, lane information, building information, or traffic information. High definition maps contain more detailed data than navigation maps. With respect to roads, the precision map may include slope, road curvature, signage information, etc. With respect to lanes, the high definition map may include lane information, lane boundary information, stop line locations, traffic light locations, signal sequences, or intersection information. The high definition map may include basic roadway information, surroundings information, detailed road environment information, or dynamic road conditions information. Detailed road environment information may include static information such as terrain elevation, curvature, lanes, lane centerlines, regulatory lines, road boundaries, road centerlines, traffic signs, pavement markings, road geometry and elevation, and/or lane widths. Dynamic road conditions information may include traffic jams, accident zones, construction zones, etc. The high definition map may include 3D realized roadway surroundings information, geometric information such as roadway shape or facility structure, or semantic information such as traffic markings or lane markings.

The controller 180 may include at least one processor, including at least one core, capable of executing program instructions. The controller 180 may execute the instructions stored in the storage unit 170. The controller 180 may include a single processor or a plurality of processors.

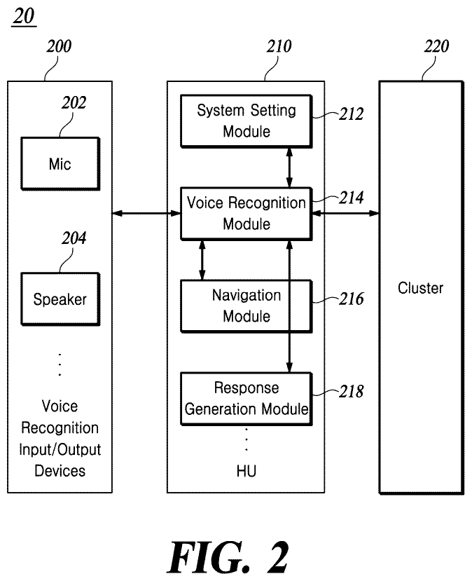

FIG. 2 is a block diagram of the configuration of a voice guidance apparatus according to at least one embodiment of the present disclosure.

A vehicle 20 may correspond to the vehicle 10 of FIG. 1. The vehicle 20 may include voice recognition input/output devices 200, a head unit (HU) 210, and an instrument cluster 220.

The input/output devices 200 may be realized as a voice recognition implementation. The input/output devices 200 may include a microphone 202 for inputting the voice of a user of the HMI 160, and a speaker 204 for outputting the necessary sound to provide voice guidance to the user. The speaker 204 outputting the voice guidance may be a loudspeaker.

The head unit 210 is part of a vehicle audio and infotainment system. The head unit 210 may include a system setting module 212, a voice recognition module 214, a navigation module 216, and a response generation module 218.

The user may select whether or not to enable a voice guidance feature and/or a recommendation feature. The system setting module 212 stores whether the user has enabled the voice guidance feature or the recommendation feature. When the voice guidance feature is enabled, the system setting module 212 is responsive to a pop-up or button displayed requiring a user response from other modules of the head unit 210 and the cluster 220, or responsive to a warning notice generated, for transmitting a voice recognition trigger signal to the voice recognition module 214.

The voice recognition module 214 obtains the user's utterance by using a microphone and converts the user's utterance to text by using at least one speech to text (STT) engine. The STT engine may apply a speech recognition algorithm or deep learning model to the user's speech signal to convert the speech signal to text. The voice recognition module 214 may transmit the text data to the response generation module 218. When the voice recognition module 214 outputs voice guidance to the user, the voice recognition module 214 receives the voice recognition trigger signal and prepares to receive voice input from the user for the voice guidance.

The navigation module 216 may include location-based services (GPS), map data, path guidance, and destination data. The navigation module 216 sends data to the response generation module 218, such as current location, changed path, and/or destination data, based on the content of the user's utterance recognized by the voice recognition module 214.

The response generation module 218 performs processing to provide a response corresponding to the intent of the user's utterance. The response generation module 218 may provide the response in various forms. The response generation module 218 may provide a response to the user utterance by using at least one of a visual, auditory, or haptic interface, for example. When the voice guidance feature is enabled, the response generation module 218 may utilize TTS to translate the content and/or information of a pop-up or button that requires a user action.

The response generation module 218 receives information from the cluster 220 and other modules to determine whether at least one of the vehicle status, driving situation, or user data satisfies predefined conditions. If the response generation module 218 determines that the predefined conditions are met, the response generation module 218 generates a response. When the user has enabled the recommendation feature, the response generation module 218 generates instructions for the recommended action. When providing the recommendation feature, if the voice guidance feature is enabled, the instructions for the recommended action are provided as voice guidance.

The vehicle status among the predefined conditions may include at least one of an engine temperature state, a fuel consumption state, a wear condition of brake pads, or a battery charge state. For example, in case of a short fuel to get to the destination, voice guidance may be provided, such as “We don't have enough fuel to get to the destination, do you want directions to the nearest gas station?”

The driving situation among the predefined conditions may include at least one of a lane departure situation, an obstacle detection situation, or a navigation guidance situation. For example, if congestion is encountered on a path in the navigation system, voice guidance may be provided, such as “I have found a detour that is faster than the current path, do you want to change to the faster path?”

The user data among the predefined conditions may include at least one of media usage information, places specified by the user, or places based on frequency of visit by the user. For example, if the user has visited a place three or more times in the last two weeks, voice guidance may be provided, such as “Shall I register here as our home or office?”

The cluster 220 generally refers to the instrument panel of a vehicle, which is a digital or analog display that provides driving-related information to a driver. The cluster 220 may include at least one of a speedometer, a tachometer (RPM gauge), an odometer, a fuel gauge, an engine temperature gauge, a check engine light, an anti-lock braking system warning light, an airbag warning light, battery warning light, tire pressure warning, electric vehicle battery level, regenerative braking level, lane keeping assist (LKA), adaptive cruise control (ACC), GPS navigation link, or head-up display link. The cluster 220 communicates the information contained in the cluster 220 to the response generation module 218.

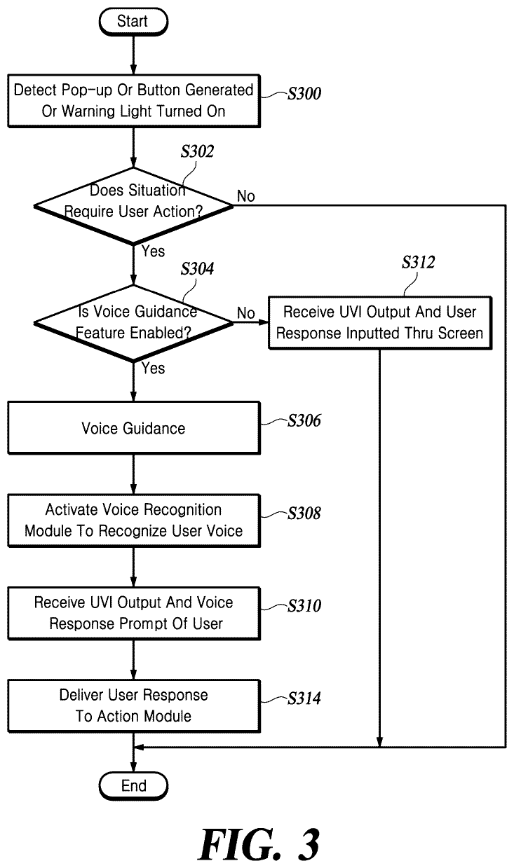

FIG. 3 is a flowchart of a voice guidance method for pop-ups from an instrument cluster and an audio, video, navigation & telecommunication (AVNT) terminal, according to at least one embodiment of the present disclosure.

In an operation S300, the voice guidance method detects a pop-up or warning light from the cluster 220 and AVNT. In an operation S302, the system setting module 212 determines whether the situation requires a user action. If the system setting module 212 determines that the user's action is required (YES in the operation S302), the system setting module 212 passes information indicating whether the voice guidance feature is enabled to the response generation module 218 in the operation S304. If the voice guidance feature is enabled (YES in the operation S304), the response generation module 218 converts the information that the user needs guidance on into speech by using text-to-speech (TTS). The speaker outputs the voice guidance in an operation S306. The system setting module 212 sends a trigger signal to the voice recognition module 214, and the voice recognition module 214 is activated, in an operation S308. In an operation S310, the voice recognition module 214 outputs information requiring a user response by using the Unified Vehicle Interface (UVI) and receives a user response by using the microphone. In an operation S314, the voice recognition module 214 converts the user's voice response to text and provides the converted text to an action module.

If the voice guidance feature is not enabled (NO in the operation S304), the voice guidance method may use the UVI to output information that requires a user response, and may receive the user response by using the unified vehicle interface (UVI), in an operation S312.

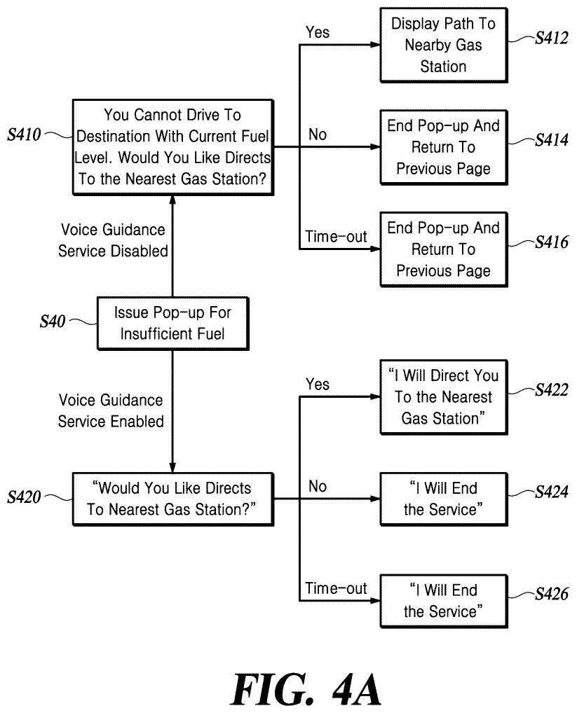

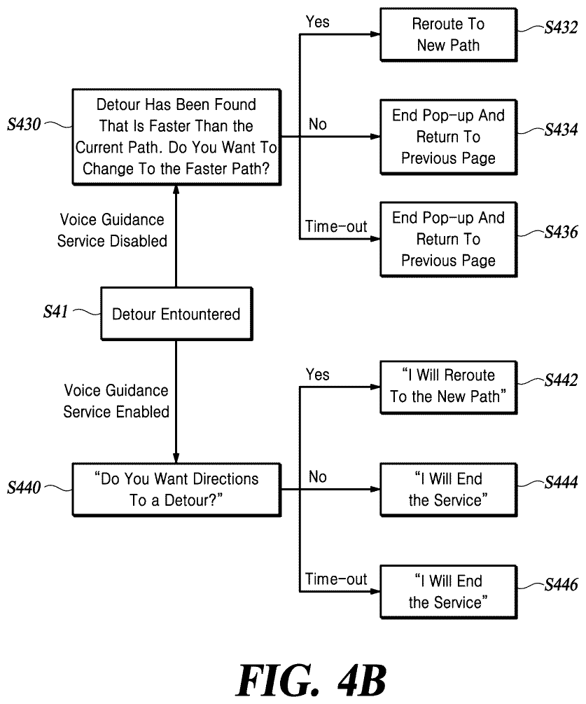

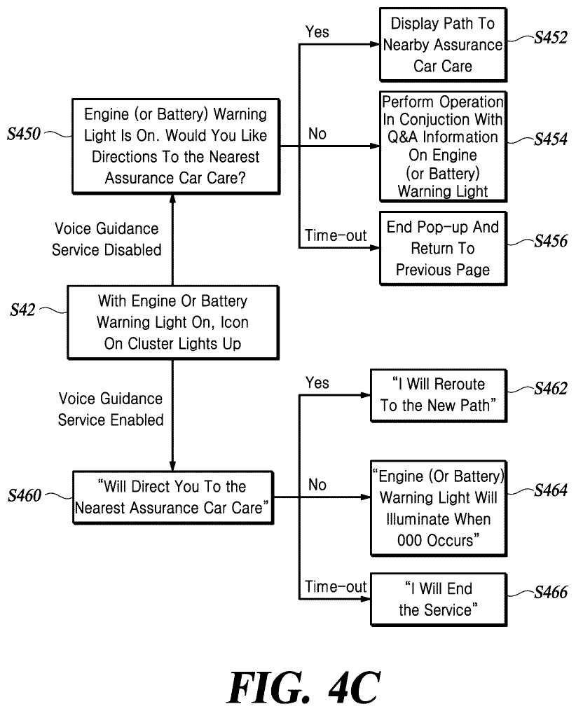

FIGS. 4A-C are diagrams illustrating voice guidance processes and responsive action processes for pop-ups on a cluster, according to some embodiments of the present disclosure.

FIG. 4A is a diagram illustrating a process for when there is insufficient gasoline to drive a vehicle to a destination, with respect to the vehicle status during predefined conditions.

While driving a vehicle by entering a destination in the navigation system, in an operation S40, a pop-up may occur in the UVI if there is insufficient fuel to drive to the destination. In an operation S410, if the voice guidance service is disabled, the vehicle may output on the UVI the message of “You cannot drive to destination with current fuel level. Would you like directions to the nearest gas station?”. The user may select ‘Yes’ or ‘No’ to the prompt, or take no action. If the user selects ‘yes’, the response generation module 218 may generate a path to a nearby gas station as a response and output the path to the UVI in an operation S412. If the user selects “No,” the vehicle may end the pop-up and return to the previous page in an operation S414. If no action is taken by the user and, for example, 10 seconds have elapsed, the vehicle may end the pop-up and return to the previous page in an operation S416.

In an operation S420, if the vehicle is enabled, the vehicle may use the speaker to output the voice guidance to tell “Would you like directions to nearby gas station?”. When providing voice guidance, the voice recognition module 214 is activated to recognize the user's response. In an operation S422, if the user responds in the affirmative, the vehicle may use the microphone to receive the user's response, may convert the user's response to text, and may provide voice guidance by using the speaker, “I will direct you to the nearest gas station”. In an operation S424, if the user responds in the negative, the vehicle may use the microphone to capture the user's response, transcribe the user's response to text, and may provide voice guidance by using the speaker, “I will end the service”. In an operation S426, if 10 seconds have elapsed without the user taking any action, the vehicle may use the speaker to output the voice guidance to tell, “I will end the service”.

FIG. 4B is a diagram illustrating a process when a detour occurs in relation to a driving situation during predefined conditions.

While driving a vehicle by entering a destination into the navigation system, if a detour is encountered, the vehicle may issue a pop-up in the UVI in an operation S41. In an operation S430, if the voice guidance service is disabled, the vehicle outputs on the UVI an announcement stating, “Detour has been found that is faster than the current path, do you want to change to the faster path?”. The user may select ‘Yes’ or ‘No’ to the prompt, or take no action. If the user selects ‘Yes’, the response generation module 218 may generate the changed path as a response and output the path to the UVI in an operation S432. If the user selects “No,” the vehicle may end the popup and return to the previous page in an operation S434. If no action is taken by the user and, for example, 10 seconds have elapsed, the vehicle may end the pop-up and return to the previous page in an operation S436.

If the voice guidance service is enabled, the vehicle may output the voice guidance by using the speaker to tell “Do you want directions to a detour?” in an operation S440. When providing voice guidance, the voice recognition module 214 is activated to recognize the user's response. If the user responds in the affirmative, the vehicle may use the microphone to receive the user's response, may convert the user's response to text, and output the voice guidance “I will reroute to the new path” by using the speaker in an operation S442. If the user responds in the negative, the vehicle may use the microphone to receive the user's response, may transcribe the user's response into text, and may issue voice guidance by using the speaker to tell, “I will end the service” in an operation S444. If 10 seconds have elapsed without the user taking any action, the vehicle may use the speaker to output the voice guidance to tell, “I will end the service” in an operation S446.

FIG. 4C is a diagram illustrating a process when an engine or battery warning light occurs in relation to the vehicle status during predefined conditions, causing the icons in the cluster to light up.

With an engine or battery warning light on, the icon on the cluster lights up in an operation S42. If the voice guidance service is disabled, the vehicle may output on the UVI the message “Engine (or battery) warning light is on. Would you like directions to the nearest Assurance Car Care?” may be displayed in the UVI in an operation S450. The user may select ‘Yes’ or ‘No’ to the prompt, or take no action. If the user selects yes, the response generation module 218 may generate a path to a nearby Assurance Car Care center as a response and may output the path to the UVI in an operation S452. If the user selects “No,” the vehicle ends the pop-up and performs the operation in conjunction with the Q&A information on the engine (or battery) warning light in an operation S454. If 10 seconds have elapsed without the user taking any action, the vehicle may end the pop-up and return to the previous page in an operation S456.

If the voice guidance service is enabled, the vehicle may use the speaker to output the voice guidance to tell, “Would you like directions to the nearest Assurance Car Care?” in an operation S460. When providing the voice guidance, the voice recognition module 214 is activated to recognize the user's response. If the user responds in the affirmative, the vehicle may use the microphone to receive the user's response, may convert the user's response to text, and may output the voice guidance “Will direct you to the nearest Assurance Car Care” by using the speaker in an operation S462. If the user responds in the negative, the vehicle may use the microphone to receive the user's response, may convert the user's response to text, and may issues voice guidance through the speaker, “Engine (or battery) warning light will illuminate when 000 occurs” in an operation S464. If 10 seconds elapse without the user taking any action, the vehicle may use the speaker to output voice guidance “I will end the service” in an operation S466.

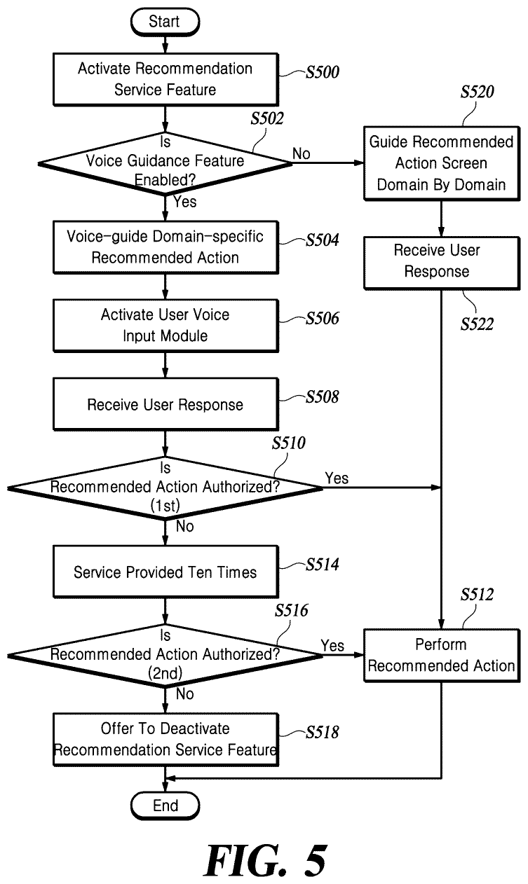

FIG. 5 is a flowchart of a voice guidance method for recommendation pop-ups or recommendation services for features provided by a vehicle, according to at least one embodiment of the present disclosure.

The voice guidance method may suggest to the user whether to enable the recommendation service feature. The user may select whether to enable the recommendation service feature in the settings window. In an operation S500, If the recommendation service feature is enabled, the system setting module 212 sends a signal to the response generation module 218 indicating that the recommendation service feature is enabled.

In an operation S502, the system setting module 212 determines whether voice guidance feature is enabled. If it is determined that the voice guidance feature is enabled (YES in the operation S502), the system setting module 212 sends, to the response generation module 218, a signal indicating that the voice guidance feature is enabled.

In an operation S504, the response generation module 218 may voice-guide a domain-specific recommended action. The domain-specific recommended action may include an announcement recommending saving a preset for a radio channel that the user frequently listens to, an announcement recommending an alternate point of interest (POI) if the destination is closed while traveling to the destination, etc.

When outputting voice guidance to the user by using a speaker, the system setting module 212 sends a trigger signal to the voice recognition module 214 in an operation S506.

The voice recognition module 214 receives the trigger signal and prepares to receive a response from the user. When the user speaks a response to the voice guidance, the voice guidance method uses the microphone to obtain the user's utterance and converts the user's utterance to text by using at least one speech to text (STT) engine in an operation S508.

If it is determined in an operation S510 that the user authorizes the recommended action (YES in the operation S510), the voice guidance method executes the recommended action in an operation S512. In an operation S514, for example if it is determined in the operation S510 that the user does not authorize the recommended action (NO in the operation S510, the vehicle may re-provide the recommended action to the user after a certain number (e.g., 10) of cycles or uses of the guidance recommendations by the user.

If it is determined in an operation S516 that the user has twice selected not to authorize the recommended action (NO in the operation S516), the voice guidance method may offer to disable the recommendation service feature in an operation S518.

When it is determined that the voice guidance feature is disabled (NO in the operation S502), the response generation module 218 may generate a domain-specific recommended action and may announce the domain-specific recommended action via the Unified Vehicle Interface (UVI) in an operation S520. The user may respond to the guided recommended action by using the UVI and the vehicle may receive user response in an operation S522. If the user approves the recommended action, the voice guidance method executes the recommended action in an operation S512.

FIGS. -E are diagrams illustrating voice guidance processes and responsive action processes, for the recommendation pop-ups or the recommendation services, according to some embodiments of the present disclosure.

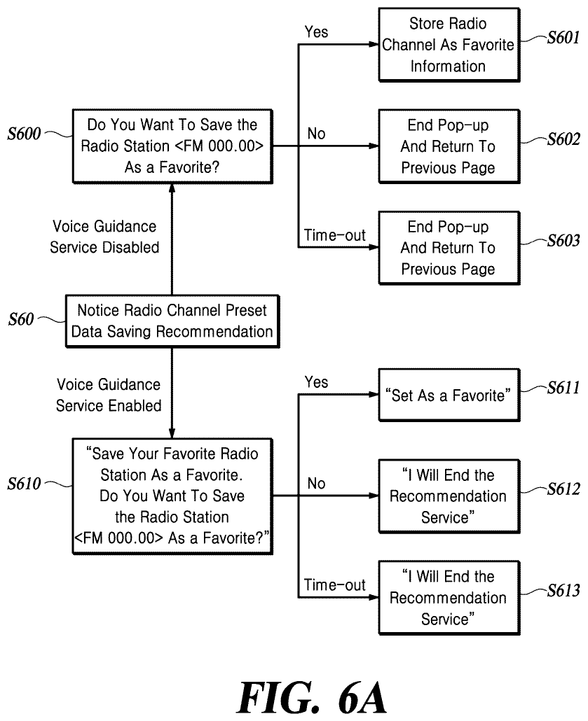

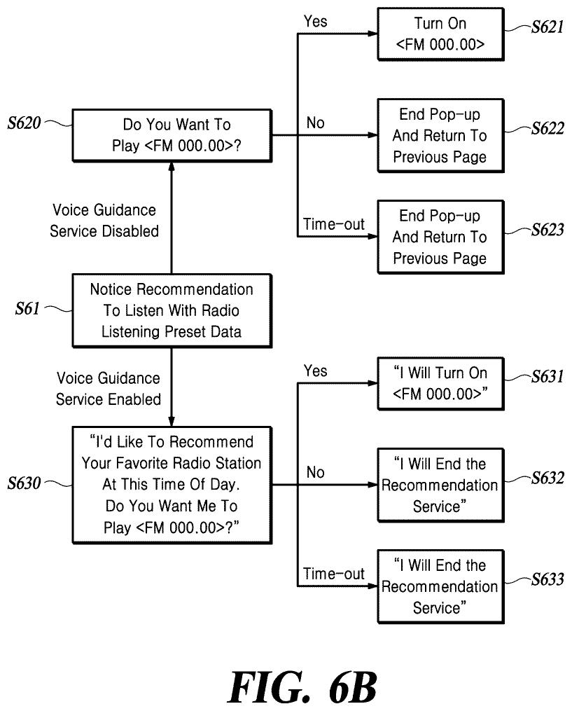

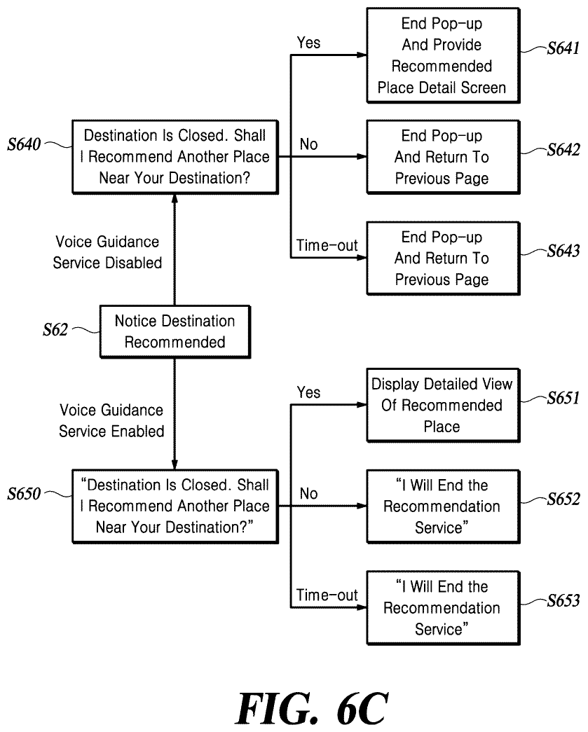

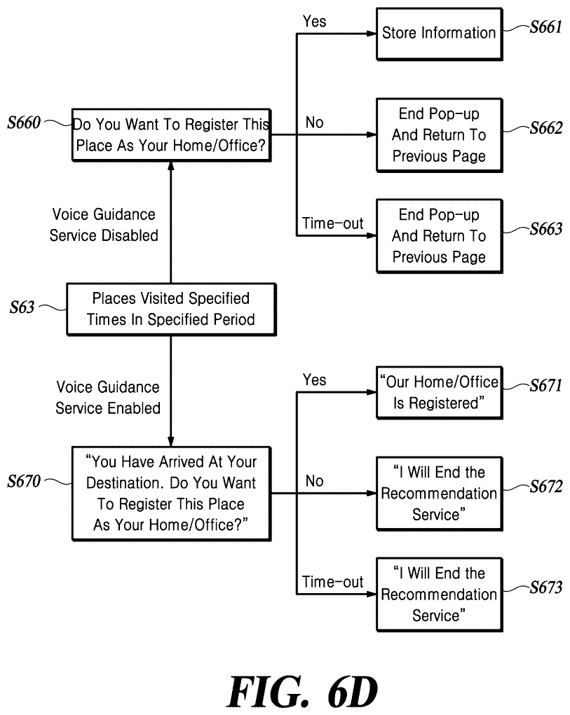

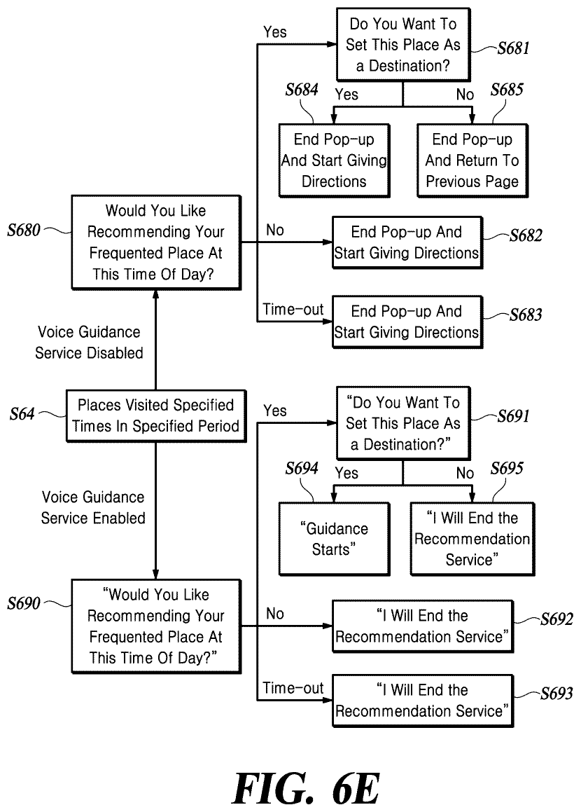

FIG. 6A is a diagram illustrating a process for recommending preset storage for channels frequently listened to by a user in relation to user data under predefined conditions.

In an operation S60, if the user cumulatively listens to a radio channel of a particular frequency at a particular time of day eight or more times per month, a radio preset save notification may occur.

If the voice guidance service is disabled, the vehicle may display on the UVI the prompt “Do you want to save the radio channel <FM 000.00> as a favorite?” in an operation S600. The user may select Yes or No to the prompt, or take no action. If the user selects ‘Yes’, the vehicle may cause the storage unit 170 to store the radio channel as favorite information in its memory in an operation S601. If the user selects “No,” the vehicle may end the pop-up and return to the previous page in an operation S602. If the user does not take any action and a certain period of time, for example, 10 seconds have elapsed, the vehicle may end the pop-up and return to the previous page in an operation S603.

If the voice guidance service is enabled, the vehicle may output the voice guidance by using the speaker, such as “Save your favorite radio station as a favorite. Do you want to save the radio station <FM 000.00> as a favorite?” in an operation S610. When providing the voice guidance, the voice recognition module 214 is activated to recognize the user's response. If the user answers in the affirmative, the vehicle may use the microphone to receive the user's response, convert it to text, and output the voice guidance “Set as a favorite” by using the speaker in an operation S611. If the user responds in the negative, the vehicle may use the microphone to receive to the user's response, transcribe it into text, and use the speaker to output the voice guidance “I will end the recommendation service” in an operation S612. If no action is taken by the user within a certain period of time, e.g., if 10 seconds has elapsed, the vehicle output voice guidance by using the speaker to say “I will end the recommendation service” in an operation S613.

FIG. 6B is a diagram illustrating a process of recommending radio listening at a stored time based on preset stored data of a channel the user is listening to in relation to user data among predefined conditions.

In an operation S61, if the user cumulatively listens to a radio channel of a particular frequency at a particular time of day a certain number of times (e.g., eight or more times per month), a notification recommending radio listening at a particular time

### Of Day May Be Generated.

If the voice guidance service is disabled, the vehicle may output on the UVI the guidance “Do you want to play <FM 000.00>?” in an operation S620. The user may select ‘Yes’ or ‘No’ to the prompt, or take no action. If the user selects ‘Yes’, the vehicle may turn on the channel corresponding to <FM 000.00> in an operation S621. If the user selects No, the vehicle may end the popup and return to the previous page in an operation S622. If the user takes no action and a certain period of time, for example, 10 seconds, have elapsed, the vehicle may end the popup and return to the previous page in an operation S623.

If the voice guidance service is enabled, the vehicle may output the voice guidance by using the speaker, such as “I'd like to recommend your favorite radio station at this time of day. Do you want me to play <FM 000.00>?” in an operation S630. When providing the voice guidance, the vehicle activates the voice recognition module 214 to recognize the user's response. If the user responds in the affirmative, the vehicle may use the microphone to receive the user's response, convert it to text, and output the voice guidance “I will turn on <FM 000.00>” by using the speaker in an operation S631. If the user responds in the negative, the vehicle may use the microphone to capture the user's response, convert it to text, and use the speaker to output the voice guidance, “I will end the recommendation service” in an operation S632. If no action is taken by the user for a certain period of time, e.g., if 10 seconds has elapsed, the vehicle may output the voice guidance by using the speaker to tell “I will end the recommendation service” in an operation S633.

FIG. 6C is a diagram of a process for recommending an alternate point of interest (POI) if the destination is closed for business hours while traveling in relation to a driving situation during predefined conditions.

If the user sets a destination and the destination is closed for business while traveling, a notification may be generated to recommend an alternative POI (Point of interest) in an operation S62.

If the voice guidance service is disabled, the vehicle may output on the UVI the message “Destination is closed. Shall I recommend another place near your destination?” in an operation S640. The user may select ‘Yes’ or ‘No’ to the prompt, or take no action. If the user selects ‘Yes’, the vehicle may end the popup and output the recommended place detail screen by using the UVI in an operation S641. If the user selects No, the vehicle may end the popup and return to the previous page in an operation S642. If the user takes no action within a certain period of time, for example if 10 seconds have elapsed, the vehicle may end the popup and may return to the previous page in an operation S643.

If the voice guidance service is enabled, the vehicle may use the speaker to output the voice guidance by using the speaker to tell “Destination is closed. Shall I recommend another place near your destination?” in an operation S650. When providing voice guidance, the vehicle activates the voice recognition module 214 to recognize the user's response. If the user responds in the affirmative, the vehicle may use the microphone to receive the user's response, may convert the user's response to text, and may display a detailed view of the recommended place after the pop-up ends by using the UVI in an operation S651. If the user responds negatively, the vehicle may use the microphone to receive the user's response, may convert the user's response to text, and may output the voice guidance “I will end the recommendation service” by using the speaker in an operation S652. If no action is taken by the user within a certain period of time, e.g., if 10 seconds has elapsed, the vehicle may output the voice guidance by using the speaker to tell “I will end the recommendation service” in an operation S653.

FIG. 6D is a diagram of a process of recommending registration as a home/office based on data of a place visited at least a certain number of times over a certain period of time in relation to user data among predefined conditions.

If the user does not have a place registered as a home/office, a notification may be generated recommending registration as a home/office based on data of places visited a certain number of times (e.g., three or more times) in the last two weeks in an operation S63.

If the voice guidance service is disabled, the vehicle may output on the Unified Vehicle Interface (UVI) the guidance “Do you want to register this place as out home/office?” in an operation S660. The user may select ‘Yes’ or ‘No’ to the prompt, or take no action. If the user selects Yes, the vehicle may store the location in memory as Home/Office in an operation S661. If the user selects ‘No’, the vehicle may end the popup and return to the previous page in an operation S662. If 10 seconds have passed without the user taking any action, the vehicle may end the popup and return to the previous page in an operation S663.

If the voice guidance service is enabled, the vehicle may output the voice guidance by using the speaker to say, “You have arrived at your destination. Do you want to register this place as our home/office?” in an operation S670. When providing the voice guidance, the vehicle activates the voice recognition module 214 to recognize the user's response. If the user answers in the affirmative, the vehicle may use the microphone to receive the user's response, convert it to text, and output the voice guidance “Our home/office is registered” by using the speaker in an operation S671. If the user responds in the negative, the vehicle may use the microphone to receive the user's response, convert it to text, and use the speaker to output the voice guidance, “I will end the recommendation service” in an operation S672. If no action is taken by the user within a certain period of time, e.g., if 10 seconds has elapsed, the vehicle may output the voice guidance by using the speaker to tell, “I will end the recommendation service” in an operation S673.

FIG. 6E is a diagram of a process of recommending a destination setting based on data of a place that the user has visited at least a certain number of times or recently at a certain time in relation to user data among predefined conditions.

In an operation S64, a notification may be generated to recommend a destination setting based on data of a place that the user has visited more than a certain number of times or recently in a certain period.

If the voice guidance service is disabled, the vehicle may output on the Unified Vehicle Interface (UVI) a guidance stating, “Would you like recommending your frequented place at this time of day?” in an operation S680. The user may select “Yes” or “No” to the prompt, or take no action. If the user selects Yes, the user may be prompted with “Do you want to set this place as a destination?” in an operation S681. If the user says yes, the vehicle may end the popup and start giving directions in an operation S684. If the user selects “No”, the vehicle may return to the previous page after the popup ends in an operation S685.

If the user selects “No” to a question provided to the user in the operation S680, the vehicle may end the popup and return to the previous page in an operation S682. If the user has not taken any action in response to a question provided to the user in the operation S680 within a certain period of time, for example if 10 seconds has elapsed, the vehicle may end the pop-up and return to the previous page in an operation S683.

If the voice guidance service is enabled, the vehicle may output voice guidance by using a speaker to tell, “Would you like recommending your frequented place at this time of day?” in an operation S690. When providing voice guidance, the vehicle activates the voice recognition module 214 to recognize the user's response. If the user responds affirmatively, the vehicle may use the microphone to receive the user's response, convert it to text, and output the voice guidance “Do you want to set this place as a destination?” by using the speaker in an operation S691. If the user answers in the affirmative, the vehicle may output the voice guidance, “Guidance starts” in an operation S694. If the user responds in the negative, the vehicle may output the voice guidance by using the speaker to tell, “I will end the recommendation service” in an operation S695.

If the user answered negatively to the question provided to the user in the operation S690, the vehicle may use the microphone to receive the user's response, transcribe it into text, and use the speaker to output the voice guidance “Exit the recommendation service” in an operation S692. If the user does not take any action in response to the question provided to the user in the operation S690 within a certain period of time, for example if 10 seconds has elapsed, the vehicle may use the speaker to announce, “The recommendation service will end” in an operation S693.

Each element of the apparatus or method in accordance with embodiments of the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein may be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an illustrative description of the technical idea of some embodiments of the present disclosure. In other words, those having ordinary skill in the art to which the present disclosure pertains should appreciate that various modifications and changes can be made without departing from essential features of the present disclosure. For example, the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the claimed invention. Therefore, embodiments of the present disclosure have been described for the sake of brevity and clarity. The scope of the technical idea of the present embodiments is not limited by the illustrations. Accordingly, one of ordinary skill in the art should understand that the scope of the present disclosure is not to be limited by the above explicitly described embodiments but by the appended claims and equivalents thereof.

According to at least one embodiment of the present disclosure, by introducing vocal conversion of information that is otherwise displayed visually, the user may be made more aware of the information being presented and the risk of accidents by minimizing the distraction by the user looking at the screen while driving may be reduced.

Furthermore, by utilizing a recommendation service, embodiments of the present disclosure may increase awareness of information that the user may otherwise pass by without noticing.

The effects of the present disclosure are not limited to those mentioned above. Other effects not mentioned herein should be more clearly understood by those of ordinary skill in the art from the above description.

Although embodiments of the present disclosure have been described for illustrative purposes, those having ordinary skill in the art should appreciate that various modifications, additions, and substitutions are possible without departing from the idea and scope of the present disclosure. Therefore, embodiments of the present disclosure have been described for the sake of brevity and clarity. The scope of the technical idea of the present disclosure is not limited by the illustrations. Accordingly, one of ordinary skill in the art should understand that the scope of the present disclosure is not limited by the above explicitly described embodiments but by the appended claims and equivalents thereof.

What is claimed is:

1. A method comprising:
generating voice guidance based on whether at least one of a vehicle status, a driving situation, or user data satisfies at least one predefined condition; and
providing the voice guidance to a user via a speaker.

2. The method of claim 1, wherein generating the voice guidance includes generating the voice guidance based on determining that a voice guidance feature is activated by the user.

3. The method of claim 1, further comprising, determining whether at least one of the vehicle status, the driving situation, or the user data satisfies the at least one predefined condition.

4. The method of claim 1, further comprising activating an input module for receiving a voice input from the user in response to providing the voice guidance to the user.

5. The method of claim 1, wherein generating the voice guidance includes, based on whether at least one of the vehicle status, the driving situation, or the user data satisfies the at least one predefined condition, generating the voice guidance to indicate a recommended action.

6. The method of claim 1, wherein the vehicle status includes least one of a temperature state of an engine, a fuel state, wear conditions of brake pads, or a charge state of a battery.

7. The method of claim 1, wherein the driving situation includes at least one of a lane departure situation, an obstacle detection situation, or a navigation guidance situation.

8. The method of claim 1, wherein the user data includes at least one of media usage information, places specified by the user, or places based on frequency of visit by the user.

9. An apparatus comprising:
a processor configured to generate voice guidance based on whether at least one of a vehicle status, a driving situation, or user data satisfies at least one predefined condition; and
a speaker configured to provide the voice guidance to a user.

10. The apparatus of claim 9, wherein the processor is configured to generate the voice guidance based on whether a voice guidance feature is activated by the user.

11. The apparatus of claim 9, wherein the processor is configured to, prior to generating the voice guidance, determine whether at least one of the vehicle status, the driving situation, or the user data satisfies the at least one predefined condition.

12. The apparatus of claim 9, wherein the processor is further configured to activate an input module configured to receive a voice input from the user in response to the voice guidance being provided to the user.

13. The apparatus of claim 9, wherein the processor is configured to, based on whether at least one of the vehicle status, the driving situation, or the user data satisfies the at least one predefined conditions, generate the voice guidance to indicate a recommended action.

14. The apparatus of claim 9, wherein the vehicle status includes at least one of a temperature state of an engine, a fuel state, wear conditions of brake pads, or a charge state of a battery.

15. The apparatus of claim 9, wherein the driving situation includes at least one of a lane departure situation, an obstacle detection situation, or a navigation guidance situation.

16. The apparatus of claim 9, wherein the user data includes at least one of media usage information, places specified by the user, or places based on frequency of visit by the user.
